(19) United States
(12) Patent Application Publication
(10) Pub. No.: US 2023/0061502 A1
(43) Pub. Date: Mar. 2, 2023

(54) PROTECTIVE COMPOSITIONS FOR USE IN SYSTEMS COMPRISING INDUSTRIAL WATER

(71) Applicant: Solugen, Inc., Houston, TX (US)

(72) Inventors: Jun Su An, Houston, TX (US); Jason Helander, Richmond, TX (US); Chris Arceo, Richmond, TX (US); Paul T. Schuber, Sugar Land, TX (US); LoongYi Tan, Houston, TX (US); Donald A. Johnson, Batavia, IL (US); Frederyk Ngantung, Houston, TX (US)

(73) Assignee: Solugen, Inc., Houston, TX (US)

(21) Appl. No.: 17/759,511

(22) PCT Filed: Feb. 5, 2021
(86) PCT No.: PCT/US2021/016961

§ 371 Date: Jul. 26, 2022

Related U.S. Application Data
(60) Provisional application No. 62/971,105, filed on Feb. 6, 2020.
(60) Provisional application No. 63/025,998, filed on May 16, 2020.
(60) Provisional application No. 63/122,334, filed on Dec. 7, 2020.

(51) Int. Cl. C02F 5/14; C02F 5/12

(52) U.S. Cl. CPC C02F 5/14; C02F 5/12; C02F 2103/023

(57) ABSTRACT

A protectant composition including at least two of the following:(a) a biochelant; (b) a chelant; (c) an acid; (d) a scale inhibitor; (e) a corrosion inhibitor; (f) an antiprecipitation additive; (g) a soluble phosphorous compound; and (h) solvent. A method for reducing the amount of ferric ion in a produced water, the method including preparing a protectant composition comprising a scale inhibitor; a biochelant; and a solvent; and introducing the composition to a produced water. A method of mitigating the formation of calcium phosphate precipitant, the method including preparing a composition including a biochelant; a soluble phosphorous compound; an antiprecipitation additive; and a solvent; and introducing the composition to a feed water disposed in a fluid conduit.

### CROSS-REFERENCE TO RELATED APPLICATIONS

This application is a 35 U.S.C. § 371 U.S. National Stage Entry application of PCT/US2021/016961 filed Feb. 5, 2021, and entitled “Protective Compositions for Use in Systems Comprising Industrial Water,” which claims benefit of U.S. provisional patent application Ser. No. 62/971,105 filed Feb. 6, 2020, and entitled “A Synergistically Enhanced Combination of Scale Inhibitor and an Iron-Control Agent.” This application also claims benefit of U.S. provisional patent application Ser. No. 63/025,998 filed May 16, 2020, and entitled “Compositions and Methods for Scale and Corrosion Inhibition,” and U.S. provisional patent application Ser. No. 63/122,334 filed Dec. 7, 2020, and entitled “Compositions for Corrosion Inhibition.” Each of the foregoing applications are hereby incorporated herein by reference in its entirety for all purposes.

### STATEMENT REGARDING FEDERALLY SPONSORED RESEARCH OR DEVELOPMENT

Not applicable.

### FIELD

The present disclosure relates generally to materials and compositions for use in systems comprising industrial water. More particularly, this disclosure relates to compositions for the protection of the integrity of surfaces contacting industrial water.

### BACKGROUND

Scaling is defined as the accumulation of undesirable materials on surfaces that come in contact with certain fluids such as water. Scaling can be found in almost every industrial, domestic or physiological activity that involves fluid flow, with or without heat transfer via the surface. Precipitation or crystallization scaling occurs in a system whenever the ionic product of a sparingly soluble salt exceeds its equilibrium solubility product. The terms scaling or scale formation are commonly used when the precipitate formed is a hard deposit such as an inverse-solubility salts (e.g. CaCO₃, CaSO₄, Ca₃(PO₄)₂). The term scaling also denotes the hard and adherent deposits that form in equipment from the inorganic constituents of water. Other typical contaminates are insoluble salts of magnesium, silica, iron, and aluminum.

Scale can deposit onto piping, evaporators, cooling towers, heat exchangers, and other process equipment. These inorganic scales have a lower heat conductivity as compared to metal surfaces, and thus, decrease the efficiency of the heat transfer process. Further, scale can adsorb onto imperfections of pipeline walls, downhole equipment, and on the walls of wellhead equipment thereby reducing production rates, jamming critical isolation or safety valves, and causing well instrument lines to plug.

Corrosion is defined as the loss of metal from the entire exposed surface of the metal and can be further categorized as uniform attack, galvanic corrosion, crevice corrosion, pitting corrosion, intergranular corrosion, selective leaching, erosion corrosion, and stress corrosion cracking. Uniform attack a common form of corrosion. It is normally characterized by a chemical or electrochemical reaction that proceeds uniformly over the entire exposed surface or over a large area. Due to uniform attack, the underlying metal becomes thinner and may eventually fail.

In galvanic corrosion a potential difference usually exists between two dissimilar metals when they are immersed in a corrosive or conductive solution. If these metals are placed in contact (or otherwise electrically coupled), the potential difference produces electron flow therebetween. Corrosion of the less corrosion-resistant metal is usually increased and corrosion of the more resistant material decreases, as compared with the behavior of these metals when they are not in contact. Crevice corrosion refers to intense localized corrosion frequently occurring within crevices and other shielded areas on metal surfaces exposed to corrosives. Pitting corrosion is a form of extremely localized attack that results in holes in the metal. Intergranular corrosion can be caused by impurities at the grain boundaries of metal-metal contacts resulting in enrichment of one of the alloying elements, or depletion of one of these elements in the grain-boundary areas. Selective leaching is the removal of one element from a solid alloy by corrosion processes. The most common example is the selective removal of zinc in brass alloys (dezincification). Erosion corrosion is the acceleration or increase in rate of deterioration or attack on a metal because of relative movement between a corrosive fluid and the metal surface. Stress-corrosion cracking refers to cracking caused by the simultaneous presence of tensile stress and a specific corrosive medium.

Despite the various types of corrosion, scaling and corrosion can have a common detrimental impact on a system. For example, scaling and/or corrosion can result in inefficient heat exchange due to the thinning of the walls of the pipes or plates, at inlets to heat exchanger tubes, at piping elbows, in piping downstream of pumps, and on pump impellers, for example. In sum, scale deposition and corrosion is a significant problem in any industry that utilizes large amounts of industrial water.

Scale inhibitors prevent the nucleation of deposits and/or impede crystal growth after nucleation has occurred. For example, phosphorous-based scale inhibitors are widely utilized and are typically characterized as either inorganic phosphates or organophosphates. Inorganic phosphates while low in cost are typically not hydrolytically stable, while organophosphate is characteristically hydrolytically stable but may be decomposed by oxidizing biocides and effective at low dosages but are typically higher in cost.

Phosphorous-based scale inhibitors are considered effective over a wide variety of conditions, but can contribute to phosphate-based scale when they degrade into phosphates. For example, they undergo degradation into phosphate species when exposed to oxidizers. These species can form phosphate-based scale, which exasperates the scaling problem. Consequently, when dosed incorrectly, these phosphates can lead to increased corrosion. Further, when phosphates are discharged to the environment, they contribute to algae blooms, which can negatively impact marine life.

An ongoing need exists for effective corrosion and scaling inhibitors with improved characteristics.

### SUMMARY

Disclosed herein is a protectant composition comprising at least two of the following:(a) a biochelant; (b) a chelant; (c) an acid; (d) a scale inhibitor; (e) a corrosion inhibitor; (f) an antiprecipitation additive; (g) a soluble phosphorous compound; and (h) solvent.

Also disclosed herein is a method for reducing the amount of ferric ion in a produced water, the method comprising preparing a protectant composition comprising a scale inhibitor; a biochelant; and a solvent; and introducing the composition to a produced water.

Also disclosed herein is a method of mitigating the formation of calcium phosphate precipitant, the method comprising preparing a composition comprising a biochelant; a soluble phosphorous compound; an antiprecipitation additive; and a solvent; and introducing the composition to a feed water disposed in a fluid conduit.

Also disclosed herein is a method for mitigating galvanic corrosion comprising introducing to an aqueous system comprising: divalent copper; and a composition comprising a biochelant, an acid, and a solvent.

Also disclosed herein is a method for providing scale and corrosion inhibition, the method comprising introducing a composition comprising a biochelant, a scale inhibitor, a corrosion inhibitor and a solvent to a system comprising industrial water.

### BRIEF DESCRIPTION OF DRAWINGS

For a detailed description of the aspects of the disclosed processes and systems, reference will now be made to the accompanying drawings in which:

FIG. 1 is a graph of the extent of scale-inhibition by samples from Example 3.

FIG. 2 is a graph of the extent of scale inhibition for the samples from Example 4.

FIG. 3 is a graph of the effect of polyaspartic acid alone or in combination with a biochelant on corrosion.

FIG. 4 is a graph of the results of a scale bottle test for the samples from Example 5.

FIG. 5 is a plot of the function of PRO-COMP as a scale inhibitor in a cool water setting.

FIG. 6 is a DSL chart for the samples from Example 6.

### DETAILED DESCRIPTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied.

Groups of elements of the periodic table are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens for Group 17 elements, among others.

The terms “conduit” and “line” are interchangeable, and as used herein, refer to a physical structure configured to flow materials (e.g., fluids) therethrough, such as pipe or tubing. The materials that flow in the “conduit” or “line” can be in a gas phase, a liquid phase, a solid phase, or a combination of these phases as usually termed “multi-phase flow.”

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. While compositions and methods are described in terms of “comprising” various components or steps, the compositions and methods can also “consist essentially of” or “consist of” the various components or steps.

Disclosed herein are compositions for use in reducing contamination of an industrial water. Herein, “industrial water” refers to water used in an industrial operation such as fabricating, processing, washing, diluting, cooling, or transporting a product; incorporating water into a product; or for sanitation needs. In an aspect, the industrial water is a feed water. Herein, a feed water refers to water used in boilers and cooling towers to ensure efficiency, maximize boiler and system life, reduce maintenance costs and maintain levels of operational performance. In another aspect, the industrial water is a produced water. Herein, a produced water is a term used in the oil industry to describe water that is produced as a byproduct during the extraction of oil and natural gas.

Disclosed herein are compositions and methods that functions to reduce scale, reduce corrosion or both. The compositions disclosed herein generally reduce the amount of deposition of a material onto an equipment's surface and/or the chemical alteration of the surface either of which is detrimental to the equipment and/or process utilizing the equipment. In an aspect, the compositions disclosed herein may improve the functioning of conventional scale or corrosion inhibitors. As such, compositions of the present disclosure may comprise a conventional scale or corrosion inhibitor as a component; however, it is to be understood the compositions disclosed herein provide an increased level or scale and/or corrosion inhibition when compared to the conventional=scale or corrosion inhibitor alone. Hereinafter, such compositions are generally termed protectant compositions and designated “PRO-COMP.”

In an aspect, a PRO-COMP of the type disclosed has one or more compounds selected from the group consisting of a chelant, a scale inhibitor, a corrosion inhibitor, an antiprecipitation additive, an acid, a soluble phosphorous compound, a biochelant, a solvent, and a combination thereof. In an aspect, a PRO-COMP of the type disclosed is formulated to address a specific application.

In an aspect, PRO-COMPs of the present disclosure comprise a biochelant. Herein, a chelant, also termed a sequestrant or a chelating agent, refers to a molecule capable of bonding a metal. The chelating agent is a ligand that contains two or more electron-donating groups so that more than one bond forms between each of the atoms on the ligand to the metal. This bond can also be dative or a coordinating covalent bond meaning the electrons from each electronegative atom provides both electrons to form the bond to the metal center. In an aspect, the chelant is a biochelant. As used herein, the prefix “bio” indicates production by a biological process such as using an enzyme catalyst.

In an aspect, the biochelant comprises an aldonic acid, uronic acid, aldaric acid or combination thereof and optionally counter cation. The counter cation may comprise an alkali metal (Group I), an alkali earth metal (Group II), or combinations thereof. In certain aspects, the counter cation is hydrogen, sodium, potassium, magnesium, calcium, strontium, cesium, or a combination thereof.

In an aspect, the biochelant comprises a glucose oxidation product, a gluconic acid oxidation product, a gluconate, or combinations thereof. The glucose oxidation product, gluconic acid oxidation product, or combination thereof is buffered to a suitable pH. Buffering can be carried out using any suitable methodology such as by using a pH adjusting material in an amount of from about 1 weight percent (wt. %) to about 10 wt. %, alternatively from about 1 wt. % to about 3 wt. %, or alternatively from about 5 wt. % to about 9 wt. % based on the total weight of the biochelant. In an aspect, the biochelant comprises from about 1 wt. % to about 8 wt. % of a caustic solution in a 20 wt. % gluconate solution.

Alternatively, the biochelant comprises a buffered glucose oxidation product, a buffered gluconic acid oxidation product or combinations thereof. In such aspects, the buffered glucose oxidation product, the buffered gluconic acid oxidation product, or combinations thereof are buffered to a suitable pH such as from about 6 to about 7, using any suitable acid or base such as sodium hydroxide. In such aspects, the biochelant comprises a mixture of gluconic acid and glucaric acid, and further comprises a minor component species comprising n-keto-acids, C₂-C₆ diacids, or combinations thereof. In an aspect, the biochelant comprises Biochelate™ metal chelation product commercially available from Solugen, Houston Tex.

The biochelant functions to effectively complex with iron in the process water. However, the biochelant can also chelate or sequester other common monovalent and divalent cations such as those seen in industrial waters. Nonlimiting examples of such monovalent and divalent cations commonly found in industrial waters include calcium, magnesium, barium, potassium, strontium, boron, aluminum, cesium, beryllium, and sodium.

In an aspect, the biochelant is present in a PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %. In an aspect, the biochelant is dosed at a concentration sufficient to provide near stoichiometric reaction concentration with the trace ions. In general, this should be a molar ratio of chelant to trace ions of 1/1, but may require molar ratios of 2/1 or 3/1.

In an aspect, the PRO-COMP comprises a chelating agent. In general, any chelating agent compatible with the other components of the PRO-COMP and able to function as a sequestrant may be utilized. In an aspect, the chelating agent comprises ethylenediaminetetraacetic acid (EDTA), hydroxyethylethylenediaminetriacetic acid (HEDTA), nitrilotriacetic acid (NTA), diethylenetriaminepentaacetic acid (DTPA), N-N′-ethylene diamine disuccinic acid, citric acid, gluconic acid, glucaric acid, glutaric acid, glucoheptonic acid, glutamic acid, and their respective salts, and mixtures thereof. Chelant may be present in the PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %. In an aspect, the PRO-COMP comprises a scale inhibitor. In general, any scale inhibitor compatible with the other components of the PRO-COMP and able to provide scale inhibition may be utilized. The scale inhibitor may inhibit scale through any number of mechanisms. For example, the scale inhibitor may react with dissolved materials in industrial water to form a very thin coating or microscopic film. In other instances, the scale may function to sequester metals from the water.

In an aspect, the scale inhibitor comprises phosphonates, organic acids, polymeric organic acids, polycarboxylics, ATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), diethylenetriamine (DETA), BTPMP (Diethylene Triamine Penta (Methylene Phosphonic Acid), PBTC (2-phosphonobutane-1,2,4-tricarboxylic acid), polymacrylates, maleic acid, polyaspartic acid and sodium aspartic acid, phosphinocarboxylates, acrylate, methacrylate; maleic copolymers such as AA-AMPS (acrylic acid-2-acrylamido-2-methylpropane sulfonic acid), and any combinations thereof. In an aspect, the scale inhibitor is present in a PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %.

In an aspect, the PRO-COMP comprises a corrosion inhibitor. In general, any corrosion inhibitor compatible with the other components of the PRO-COMP and able to provide corrosion inhibition may be utilized. In an aspect, the corrosion inhibitor comprises poly/orthophosphates, phosphonates, zinc, nitrite, molybdate compounds, azoles, benzimidazoles, silicates, or a combination thereof. In an aspect, the corrosion inhibitor is present in a PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %.

In an aspect, the PRO-COMP comprises an acid. In general, any acid compatible with the other components of the PRO-COMP and able to provide acidic species may be utilized. Nonlimiting examples of acids suitable for use in the present disclosure include citric acid, glutaric acid, ethylene diamine disuccinic acid, iminodisuccnic acid, methylglycine N,N-diacetic acid, glutamic acid, ethylene diamine tetraacetic acid, hydroxyethyl ethylene diamine triacetic acid, diethyene triamine pentaacetic acid, salts thereof, or combinations thereof. In an aspect, the acid is present in a PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %.

In an aspect, the PRO-COMP comprises an antiprecipitation additive. In general, any antiprecipitation additive compatible with the other components of the PRO-COMP and able to this functionality may be utilized. In an aspect, the antiprecipitation additive comprises low molecular weight organic polymers, containing combinations of carboxylic acid, sulfonic acid and nonionic functional groups, provided by polymerization of monomers containing said functional groups. Nonlimiting examples of monomers providing carboxylic acid functionality are acrylic, methacrylic, itaconic, maleic and aspartic acids. Nonlimiting examples of monomers providing strong acid functionality are vinyl sulfonic, styrene sulfonic acid, allyl hydroxypropylether sulfonic acid, 2-methyl acrylimidopropane and methacrylamidopropane sulfonic acids, allyl and methallyl sulfonic acid, allyl polyepoxyether sulfate, and salts thereof. Nonlimiting examples of monomers providing nonionic functionality are acrylic and methacrylic acid alkyl esters, acrylamide and N-alkyl acrylamides, styrene, and allyl epoxy ethers. In an aspect, the antiprecipitation additive is present in a PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %.

In an aspect, the PRO-COMP comprises a soluble phosphorous compound. In general, any soluble phosphorous compound compatible with the other components of the PRO-COMP and able to this functionality may be utilized. In an aspect, the soluble phosphorous compound comprises orthophosphate, polyphosphates such as pyrophosphate, hexametaphosphate or higher polyphosphates, organic phosphate esters, organic phosphonates, or a combination thereof. In an aspect, the soluble phosphorous compound is present in a PRO-COMP in an amount of from about 1 weight percent (wt. %) to about 90 wt. % based on the total weight of the composition, alternatively from about 5 wt. % to about 80 wt. % or alternatively from about 10 wt. % to about 75 wt. %.

In an aspect, a PRO-COMP further comprises a solvent. In general, any solvent compatible with the PRO-COMP and/or activity to be undertaken may be utilized. In an aspect, the solvent comprises water, an alcohol or a polyol. In an aspect, the polyol can be an aliphatic polyol such as ethylene glycol, diethylene glycol, triethylene glycol, tetraethylene glycol, tripropylene glycol 1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or combinations thereof. Non-limiting examples of suitable alcohols which can be utilized as a solvent include methanol, ethanol, propanol, isopropanol, n-butanol, isobutanol, pentanol, hexanol, heptanol, octanol, benzyl alcohol, phenol, cyclohexanol, and the like, or combinations thereof. In an aspect, the solvent comprises water, methanol, ethanol, ethylene glycol, propylene glycol, or a combination thereof.

In an aspect, solvent may be present in an amount of from about 10% to about 100% based on the total volume of the composition. In an alternative aspect, solvent may be present in the PRO-COMP in an amount that constitutes the remainder of the composition once all other components are accounted for.

In one or more aspects, a PRO-COMP of the type disclosed herein, can be prepared using any suitable methodology. For example, two or more components (e.g., biochelant and solvent) may be blended or mixed in a suitable vessel (e.g., container, blender etc.). In some aspects, the components of the PRO-COMP may be mixed to form a homogenous mixture that can subsequently be introduced to a system in order to facilitate scale inhibition and/or corrosion inhibition. A PRO-COMP may be introduced to a system that utilizes industrial water, such as and without limitation cooling towers, boilers, evaporators, heat exchangers, chillers, reverse osmosis/filtration systems and distillation/separation processes. In another aspect, the PRO-COMP may be introduced to water used in oilfield servicing such as produced water.

In an aspect, a PRO-COMP of the present disclosure is formulated for reducing the amount of ferric ion (Fe³⁺) in produced water. Such a PRO-COMP is hereinafter designated “PRO-COMP₁.” In an aspect PRO-COMP₁, comprises a scale inhibitor, a biochelant, and optionally a solvent, each of the type disclosed herein. Introduction of a PRO-COMP₁ to produced water may reduce the amount of ferric ion in solution and inhibit the formation of inorganic scales. As a result of reducing the amount of free iron present in the produced water the MIC of the scale inhibitor may be substantially reduced. Thus, a PRO-COMP₁ functions to unexpectedly, beneficially and synergistically improve the ability of conventional scale inhibitors to block or prevent the buildup of scale.

In an aspect, a PRO-COMP of the type disclosed herein functions to mitigate the formation of a calcium phosphate precipitant and is designated “PRO-COMP₂.” In an aspect, PRO-COMP₂ when utilized in systems such as an aqueous cooling medium (e.g., cooling tower) which contains calcium hardness and an amount of trace metal ions may prevent the formation of a calcium phosphate precipitant. The trace ions can comprise one or more of iron (II), iron (III), aluminum (III) and manganese (II) which may be present at concentrations ranging from about 0.25 mg/liter to about 5 mg/liter.

In an aspect, PRO-COMP₂ comprises a biochelant, a soluble phosphorous compound, an antiprecipitation additive and optionally a solvent. The biochelant may be dosed at a concentration sufficient to provide near stoichiometric reaction concentration with the trace ions. In general, this results in a molar ratio of biochelant to trace ions of from about 1:1 to about 3:1 or alternatively from about 1:1 to about 2:1.

In an aspect, a PRO-COMP of the present disclosure is formulated to address galvanic corrosion. Galvanic corrosion which results from dissimilar metals exposed to a fluid medium with an electrical connection there between. This corrosion can result from the use of metals with different electrochemical oxidation potentials or more insidiously from reductive deposits of dissimilar metals from the aqueous medium. A particularly damaging form of galvanic corrosion results from the reductive deposition (plating) of copper ions onto the surface of more reactive metals such as iron, aluminum or zinc/galvanized steel. Soluble copper can enter aqueous systems in two main ways. In the first instance, copper alloys are widely used as materials of construction. For example, copper piping and components are ubiquitous in water distribution systems, and often introduce significant amounts of soluble Cu⁺² into the water supplied. When corrosion of copper materials occurs, it initially produces Cu⁺¹ ions which are relatively insoluble under typical conditions, and which interact with known copper inhibitors to form protective films. Upon exposure to dissolved oxygen or other oxidizers, such as oxidizing biocides, this film can be oxidized to the Cu⁺² oxidation state which is more soluble in water and less interactive with inhibitors.

The second major mode of contamination is through the introduction of copper-contaminated makeup water. Thus, whether the source of the copper is from corrosion of copper alloys included in the system or from copper-contaminated influent streams, the resulting islands of copper metal can act as sites for localized galvanic corrosion of the underlying reactive metal.

In an aspect, a PRO-COMP of the present disclosure, designated “PRO-COMPS” is formulated for prevention of copper redeposition in aqueous systems and mitigating the resulting localized galvanic corrosion. In an aspect, PRO-COMPS comprises a biochelant, an acid, and optionally a solvent. Each of these components of PRO-COMPS may be present in an amount suitable to meet some user and/or process goal.

In an aspect, a PRO-COMP of the type disclosed herein is formulated as a multifunctional additive for the reduction, removal or inhibition of scale and/or corrosion and designated “PRO-COMP₄.” These compositions may reduce/inhibit or prevent the formation or scale or corrosion in industrial systems employing water. Herein “water” refers to freshwater, seawater, saltwater, process water, brine (e.g., underground natural brine, formulated brine, etc.), and combinations thereof. Generally, the water may be from any source.

In one or more aspects, PRO-COMPO comprises a biochelant, a scale inhibitor, a corrosion inhibitor, and optionally a solvent.

Any PRO-COMP may be introduced to a system in amounts effective to facilitate some user and/or process targeted activity (e.g., scale or corrosion inhibition). For example, in order to effectively control scale deposition, the PRO-COMP may have to be present above a certain concentration. The minimum inhibitor level required to prevent scale deposition is commonly referred to as “minimum inhibitory concentration” (MIC) or “minimum effective concentration” (MEC). In one or more aspects, a system having a PRO-COMP introduced may be monitored to ensure the amount of the PRO-COMP retains some MIC or MEC for that particular system.

In an aspect, the PRO-COMP is introduced to a system using any suitable methodology such as being injected into an appropriate input of the system, such as at a port or valve that allows the PRO-COMP to contact and function. In an aspect, a method of the present disclosure further comprises monitoring system parameters such as solute concentrations and adjusting the PRO-COMP level to maintain a level of functionality in some user and/or process desired range. In an aspect, a PRO-COMP of the type disclosed herein may be introduced to a system manually. In an alternative embodiment, the PRO-COMP introduction may be automated. A method may be developed to monitor the concentration of PRO-COMP in a system. Monitoring of the PRO-COMP dosage in a system may be continuous, semi-continuous, discrete, automated, manual, or a combination thereof.

The method can be programmed into a device such as a pump to deliver an amount of PRO-COMP that result in some predefined dose that is at least the MIC or MEC for that particular system. The method may be automated by use of any suitable supply device such as a material feeder or pumps such as a programmable pump. The device such as a pump can be programmed to operate at specific times for specific run time intervals to add maintenance doses of PRO-COMP to the volume of water undergoing treatment.

In some aspects, a synergistic effect is observed when the PRO-COMP is utilized in conjunction with a conventional scale inhibitor or corrosion inhibitor (e.g., phosphate-containing compound). This may result in a reduction in the minimal concentration of scale and/or corrosion inhibitor needed to effectively address the scaling or corrosion issues. In other words, with the addition of a PRO-COMP, the amount of conventional scale/corrosion inhibitor needed to affect the same level of scale or corrosion inhibition may be reduced by equal to or greater than about 10%, alternatively equal to or greater than about 15% or equal to or greater than about 20%. The result is a reduction in the use of conventional scale/corrosion inhibitors with the concomitant reduction in cost and environmental impact.

These compositions may reduce/inhibit or prevent the formation or scale or corrosion in industrial systems employing water. Herein, “water” refers to freshwater, seawater, saltwater, brine (e.g., underground natural brine, formulated brine, etc.), and combinations thereof. Generally, the water may be from any source.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

A PRO-COMP of the type disclosed herein was prepared and evaluated for its' corrosion inhibiting effectiveness. The following materials were used, a C1018 coupon, a 30% active sodium gluconate solution (SG30L), a 30% solution of Na₄EDTA, a 30% solution of HEDP, a heat bath, KOH for titration and N₂ gas (for sparging). Two scenarios were contemplated: the first addressed industrial water present in a cooling tower. In the case of industrial water in a cooling tower, the experiment was carried out as follows: 3 coupons were prepared and their initial weights recorded. The following solutions were prepared SG3OL, Na₄EDTA, HEDP and it was ensured they were all 30% active prior to titrating the solution pH to 9. Coupons were added to each solution and the sample placed in a heat bath at 100° F. for 24 hours, after which the coupons were removed and their weights recorded.

In the case of a scenario, simulating industrial water in a boiler the following procedure was employed. Three coupons were prepared and their initial weights recorded. The following solutions were prepared SG30L, Na₄EDTA, HEDP and sparged with nitrogen to ensure anaerobic conditions. It was ensured that all solutions were all 30% active prior to titrating the solution pH to 9. Coupons were added to each solution and the sample placed in a heat bath at 180° F. for 24 hours, Subsequently the coupons were removed and their weights recorded and corrosion rate in terms of mils per year (MPY) calculated. The results of these experiments are presented in Table 1.

TABLE 1
Neat Chemical Corrosion Results

| | Metallurgy- | Temp | | | N2 | Mass, | Mass, | Mass | Corrosion |
|---|---|---|---|---|---|---|---|---|---|
| Test | ID | [deg F.] | Chemical | pH | Sparge | initial [g] | final [g] | loss [g] | Rate (mpy) |
| 1 | C1018-3898 | 180 | SG30L | 9 | Y | 11.9892 | 11.9801 | 9.1 | 7.53 |
| 2 | C1018-3871 | 180 | 30% EDTA | 9 | Y | 11.8979 | 11.8843 | 13.6 | 11.11 |
| 3 | C1018-3872 | 180 | 30% HEDP | 9 | Y | 11.9445 | 8.5033 | 3441.2 | 2819.61 |
| 4 | C1018-3873 | 100 | SG30L | 9 | N | 12.0049 | 12.0037 | 1.2 | 0.98 |
| 5 | C1018-3874 | 100 | 30% EDTA | 9 | N | 11.9952 | 11.994 | 1.2 | 0.98 |
| 6 | C1018-3875 | 100 | 30% HEDP | 9 | N | 11.964 | 11.8112 | 152.8 | 126.05 |

As seen in Table 1 above, the coupons with 30% sodium gluconate exhibited the least amount of corrosion at 180° F. At 100° F., the corrosion rate of 30% sodium gluconate is equal to that observed using the 30% Na₄EDTA solution.

### Example 2

An investigation of the ability of a PRO-COMP to boost the performance of a traditional corrosion inhibitor was carried out. Specifically, a PRO-COMP comprising a biochelant was prepared and its function as a corrosion inhibitor compared to that of azoles. Azoles are ringed organic molecules that are used as corrosion inhibitors for copper and copper alloys. In this experiment, the corrosion of 3 copper coupons, designated A, B, and C, in 100° C. water containing the amount of sodium (Na), potassium (K) and magnesium indicated in Table 2 was monitored. To the water solution of coupon A was added 2 ppm of the azole, tolytriazole while a biochelant A was added to coupon B and biochelant B added to coupon C. Biochelant A and B are different mixtures of biochelants. The pH of the solution was 9. The copper coupons were weighed and then allowed to sit in the aqueous solution for 48 hours before being weighed again. The results of these experiments are shown in Table 3.

TABLE 2
Water Composition

| Cations | Mg/L | Anions | ppm |
|---|---|---|---|
| Na⁺ | 544 | HCO₃⁻ | 269 |
| K⁺ | | Cl⁻ | 540 |
| Mg²⁺ | 37 | SO₄²⁻ | 680 |

TABLE 3

| | | | | Weight | | |
|---|---|---|---|---|---|---|
| | | | Initial | After | Weight | Corrosion |
| | | Chelant | Weight | Cleaning | Loss | Rate |
| Coupon | BioChelant | PPm | (g) | (g) | (mg) | (mpy) |
| A | None | 0 | 12.96 | 12.953 | 7 | ~3 |
| B | Biochelant A | 8 | 12.946 | 12.943 | 3 | ~1 |
| C | Biochelant B | 8 | 12.621 | 12.619 | 2 | 0.7 |

The results in Table 3 demonstrate there is a performance boost of tolytriazole upon the addition of of Biochelant A or Biochelant B.

### Example 3

An investigation of the ability of a PRO-COMP to boost the performance of a traditional scale inhibitor was carried out. Specifically, a PRO-COMP comprising a biochelant was prepared and its function as a scale inhibitor compared to that of HEDP. HEDP is a well-known scale inhibitor, but it can be corrosive, as well as leading to eutrophication issues.

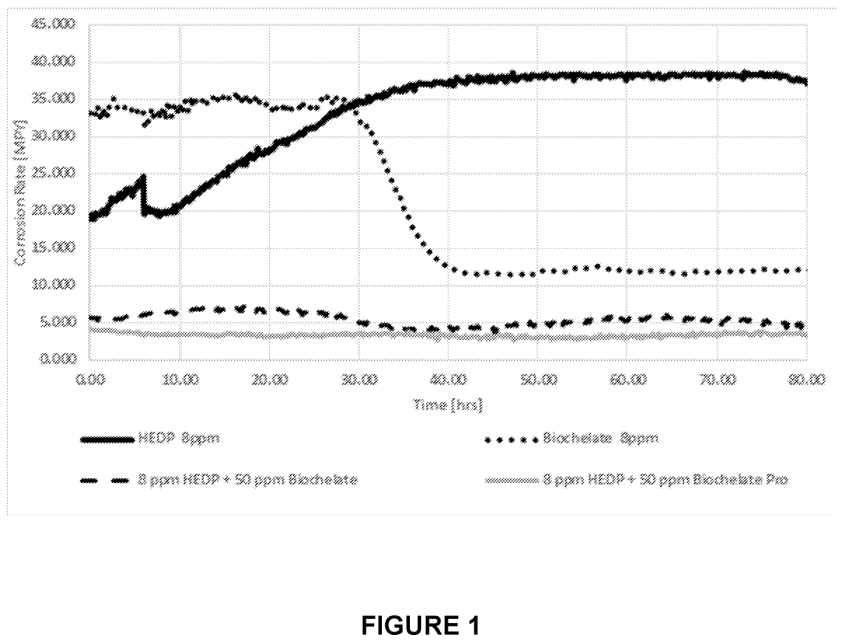

This experiment was carried out using water containing the amount of sodium (Na), potassium (K) and magnesium indicated in Table 2 was monitored. Carbon steel coupons were incubated at 32° C. under an O₂ purge while rotating at 100 rpm. Coupons were incubated with 8 ppm HEDP, 8 ppm of Biochelant A, 8 ppm HEDP and 50 ppm Biochelant A or 8 ppm HEDP and Biochelant B. The test was performed in a corrosion kettle, with a COSASCO linear polarization resistance (LPR) probe. Corrosion kettle testing basically uses Ohms Law to convert potential transients into charge and metal loss by localized corrosion. The results of these experiments are shown in FIG. 1 where the dosages indicated are active (dry) dosages.

As shown in FIG. 1, the addition of Biochelant A or Biochelant B yielded a significant reduction in corrosion rate (MPY, mils per year). At hour 50, HEDP exhibited a corrosion rate of approximately 37 MPY, whereas the formulation with Biochelant A and Biochelant B yielded a corrosion rate of approximately 5 and 3 MPY, respectively.

### Example 4

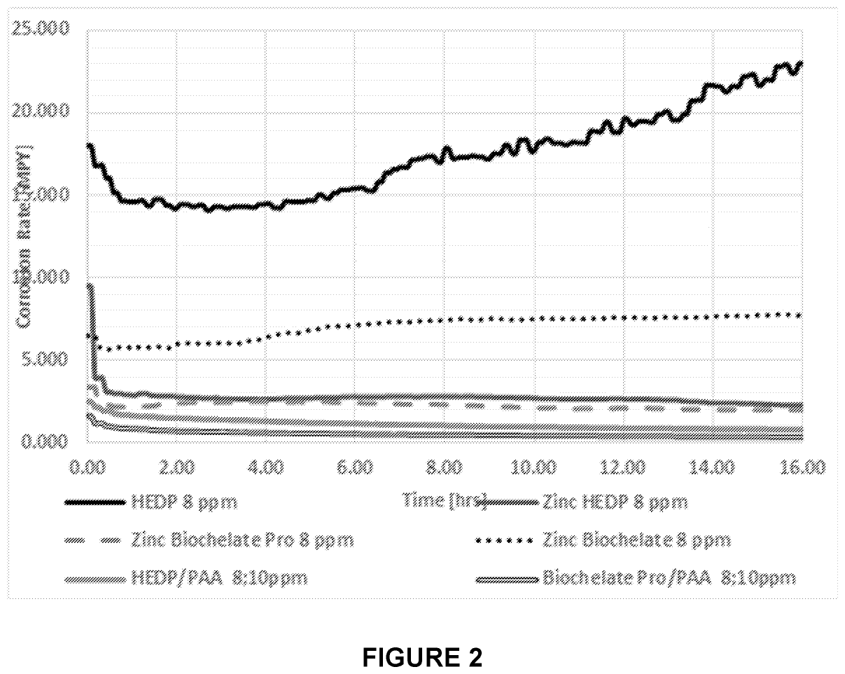

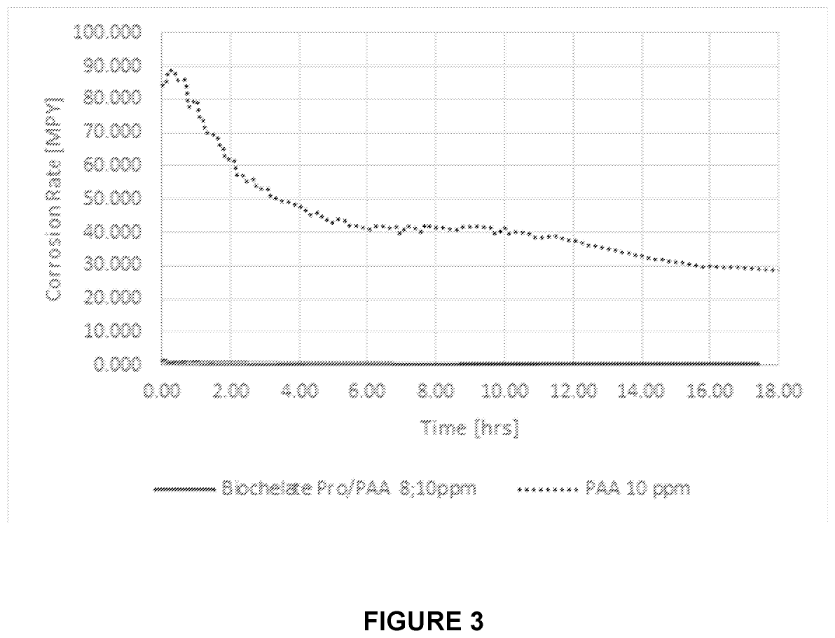

A similar experiment was carried out under the test conditions described in Example 3 to determine if a zinc-free and phosphate-free formulation could be achieved. The results of these experiments are presented in FIG. 2. Referring to FIG. 2, a formulation with Biochelant B and Polyaspartic Acid (PAA) resulted the best performance, wherein the corrosion rate was less than 1 MPY, and outperformed other formulations with zinc or phosphonate/phosphates. As noted in FIG. 3, PAA was ineffective at inhibiting corrosion, as seen by the high corrosion rate of approximately 40 MPY at hr 6, while the formulation with Biochelant B resulted in a corrosion rate of less than 1 MPY.

### Example 5

A scale bottle test with calcite brine was carried out using a dynamic scale loop (DSL). A National Association of Corrosion Engineers (NACE) brine was prepared in accordance to NACE test standards. However, the procedure was modified to include 10 ppm of ferric iron Fe(III). The procedure involved preparing a Ca brine by adding 12.15 g/L CaCI, 3.68 g/L MgCl2, and 33 g/L NaCI. Bicarbonate brine was prepared by adding 33 g/L NaCI to 7.36 g/L NaHCO3. Both brines were sparged with N2 to remove oxygen. 50 mL of Ca brine and dose 10 ppm of Fe(III), and product were measured out and bicarb brine added. The bottle was shaken and set in a 60° C. water bath for 24 hours. After these formulations were tested, the calcium concentrations were analyzed and the results summarized in Table 4. Here, the higher calcium concentration per active product results in a more effective product.

TABLE 4

| | | | Total | | | |
|---|---|---|---|---|---|---|
| | % Scale | % | Activity | Dosage | Ca | Ca/ |
| Product | Inhibitor | BioChelate | % | ppm | mg/L | % Activity |
| 25 PAPMP/25 Biochelate | 12.5 | 12.5 | 25 | 250 | 1918.0 | 76.7 |
| 25 HEDP/25 Biochelate | 12.5 | 12.5 | 25 | 250 | 1560.1 | 62.4 |
| 25 PBTC/25 Biochelate | 12.5 | 12.5 | 25 | 250 | 1470.5 | 58.8 |
| 25 BHMT/25 Biochelate | 12.5 | 12.5 | 25 | 250 | 1454.6 | 58.2 |
| 25 AEEA/25 Biochelate | 12.5 | 12.5 | 25 | 250 | 1351.7 | 54.1 |
| 40 BHMT/10 Biochelate | 20 | 6 | 26 | 250 | 1388.7 | 53.4 |
| 40 PBTC/10 Biochelate | 20 | 6 | 26 | 250 | 1374.7 | 52.9 |
| 40 AEEA/10 Biochelate | 20 | 6 | 26 | 250 | 1337.7 | 51.5 |
| 10 PAPMP/40 Biochelate | 5 | 24 | 29 | 250 | 1455.4 | 50.2 |
| 10 PBTC/40 Biochelate | 5 | 24 | 29 | 250 | 1455.4 | 50.2 |
| 25 DETA/25 Biochelate | 12.5 | 12.5 | 25 | 250 | 1247.2 | 49.9 |
| 10 HEDP/40 Biochelate | 5 | 24 | 29 | 250 | 1412.4 | 48.7 |
| 40 DETA/10 Biochelate | 20 | 6 | 26 | 250 | 1264.5 | 48.6 |
| 10 BHMT/40 Biochelate | 5 | 24 | 29 | 250 | 1362.8 | 47.0 |
| 40 PAPMP/10 Biochelate | 20 | 6 | 26 | 250 | 1132.4 | 43.6 |
| PAPMP | 50 | 0 | 50 | 250 | 2099.2 | 42.0 |
| 10 DETA/40 Biochelate | 5 | 24 | 29 | 250 | 1195.3 | 41.2 |
| 10 AEEA/40 Biochelate | 5 | 24 | 29 | 250 | 1123.6 | 38.7 |
| PBTC | 50 | 0 | 50 | 250 | 1686.9 | 33.7 |
| BHMT | 50 | 0 | 50 | 250 | 1647.1 | 32.9 |
| BHMT | 50 | 0 | 50 | 250 | 1647.1 | 32.9 |
| PAPMP | 50 | 0 | 50 | 250 | 1635.1 | 32.7 |
| PBTC | 50 | 0 | 50 | 250 | 1599.0 | 32.0 |
| AEEA | 50 | 0 | 50 | 250 | 1484.1 | 29.7 |
| AEEA | 50 | 0 | 50 | 250 | 1484.1 | 29.7 |
| HEDP | 50 | 0 | 50 | 250 | 1430.2 | 28.6 |
| HEDP | 50 | 0 | 50 | 250 | 1382.6 | 27.7 |

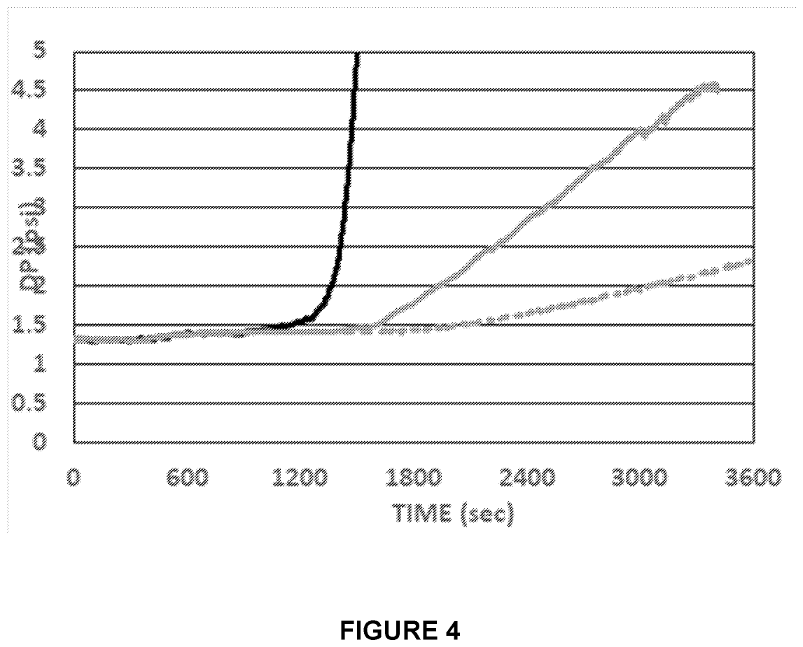

As seen in the table above, all the formulations with a biochelant of the type disclosed herein resulted highest calcium concentration, when normalized for activity. The experiment was repeated using a dynamic condition having a 10 cc/min flow rate, a temperature of 160° F. and a back-pressure regulator (BPR) set at 500 psi. The results of these experiments are presented in FIG. 4. Referring to FIG. 4, the blank (no additive) resulted scaled off (reached a dP of 2 psi) in about 1400 seconds. The HEDP run scaled off in 2000 seconds, while the Biochelant and HEDP formula scaled off in 3000 seconds. This result was quite unexpected, as the HEDP and Biochelant run contained 50% less threshold inhibitor HEDP (the formulation contains 3 ppm HEDP and 3 ppm Biochelant, resulting a total dry dosage of 6 ppm).

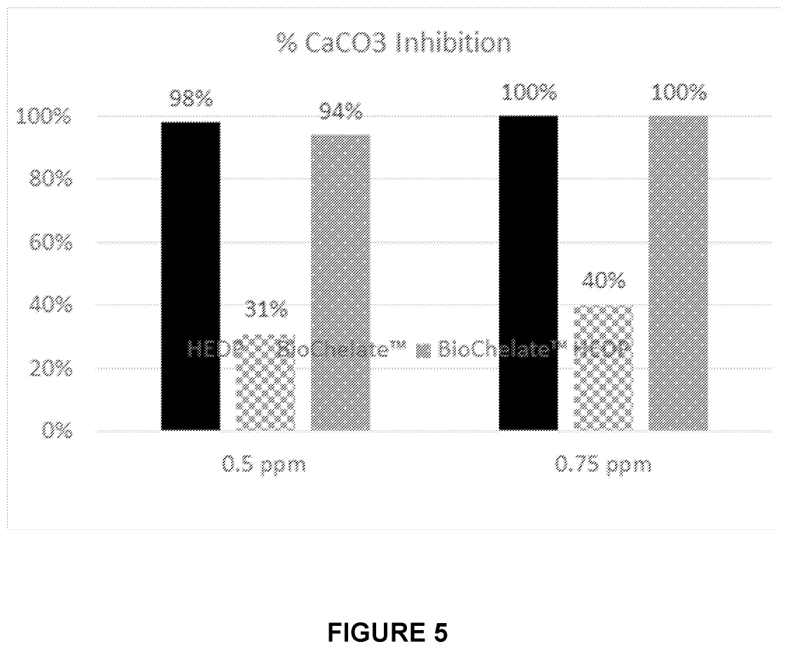

A similar experiment was carried out to investigate the functionality of a PRO-COMP in an everyday cooling water setting. Specifically, calcium carbonate inhibition was investigated for a time period of 24 hr ±2 hr at a temperature of 60° C. (140° F.), a pH ranging form 8 to 8.2 in the presence of 200 mg/L Ca²⁺ and 600 mg/L HCO₃⁻ (492 mg/L as CaCO₃). Referring to FIG. 5, the results indicate that there is a synergistic effect between HEDP and Biochelant, where the Biochelant HEDP blend can achieve the same performance of HEDP with 50% less phosphonates.

### Example 6

A set of DSL tests were conducted using a PRO-COMP comprising a biochelant and a number of different phosphonate scale inhibitors that simulated West Texas brine conditions. The composition of the brine is given in Table 5.

TABLE 5

| Cations | mg/L | Anions | ppm |
|---|---|---|---|
| Na+ | 38671 | HCO3— | 2262 |
| K+ | 1037 | Cl— | 63465 |
| Mg++ | 172 | SO4═ | 2847 |
| Ca++ | 2092 | Br— | |
| Fe++ | | I— | |
| Sr++ | 112 | CH3COO— | 0 |
| Ba++ | 0 | S2— | |
| Other Comments | | HCOO— | |

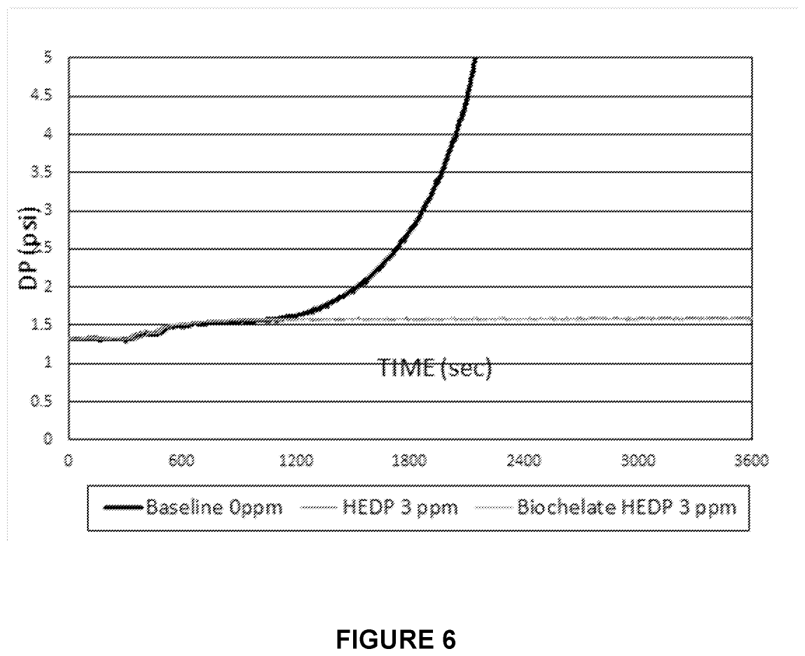

The purpose of the DSL runs were to see if the same synergistic effect (less phosphonate when combined with Biochelant) could be observed. As seen in the DSL chart of FIG. 6, the run with HEDP and Biochelant HEDP are indistinguishable, resulting in the same performance with half the amount of HEDP phosphonate. Similar results were observed in a static test setting where the brine composition is given in Table 6.

TABLE 6

| Cations | mg/L | Anions | ppm |
|---|---|---|---|
| Na+ | 38671 | HCO3— | 1131 |
| K+ | 1037 | Cl— | 63465 |
| Mg++ | 172 | SO4═ | 2847 |
| Ca++ | 1046 | Br— | |
| Fe++ | | I— | |
| Sr++ | 112 | CH3COO— | 398 |
| Ba++ | 24 | S2— | |

| | |
|---|---|
| Other Comments | HCOO— |

In this experiment, the brine was prepared in a bottle dosed with the additives, and placed in a heat bath for 24 hrs. The bottles were then analyzed via inductively coupled plasma (ICP). Here, the higher cation concentration via ICP will yield a better performing additive, as higher cation count yields less scale.

TABLE 7

| Additive | ppm dry | Ca [ppm] | Sr [ppm] |
|---|---|---|---|
| Biochelant | 3 | 1084.15 | 116.42 |
| HEDP | | | |
| HEDP | 3 | 1056.52 | 113.86 |

As seen in the table above, the bottle test of Biochelant HEDP resulted in higher Ca and Sr concentration, even though there are half the amount of HEDP in the bottle.

### Example 7

To determine the effects of copper contamination on corrosion rate, the following water composition was prepared, and a set of C1018 electrodes were placed in a water bath sparging with air and with the water composition seen below.

TABLE 8
Test Conditions

| | |
|---|---|
| Temperature (C.) | 32 |
| Water Cut (%) | 100 |
| Brine | See below |
| Coupon Material | C1018 |
| Purge Gas | Air |
| Rotation Speed RPM | 600 |

TABLE 9

Water Composition

| Cations | Mg/L | Anions | ppm |
|---|---|---|---|
| Na+ | 544 | HCO3— | 269 |
| K+ | | Cl— | 540 |
| Mg++ | 37 | SO4═ | 680 |
| Ca++ | 142 | Br— | |

In this first set seen directly below, the detrimental effect of copper can be seen. As copper is added into the water, the weight loss is dramatically increased. Additionally, the copper has been deposited onto the electrode, accelerating localized corrosion.

TABLE 10

| | | | | | | Chelant | Cu ICP after | Weight |
|---|---|---|---|---|---|---|---|---|
| | | | Electrode | Copper | | Dosage | nitric ppm | Loss |
| Test | Hrs | Water | Type | ppm | Chelant | ppm Dry | (on coupon) | [mg] |
| 1 | 120 | IWT Brine | C1018 | 0 | None | 0 | 13.82 | 258.5 |
| 2 | 120 | IWT Brine | C1018 | 10 | None | 0 | 102.61 | 357.05 |

After observing the detrimental effect of copper, another set of tests were ran to determine the effect of Biochelant on corrosion rate. As seen in the Table 11, the addition of Biochelant led to a decrease in corrosion. The run with copper and no chelant resulted in a significantly higher weight loss. As a result, the effect of Biochelant can be clearly seen. It effectively chelates copper and reduces any copper redeposition and copper-induced corrosion of carbon steel. This chelation property will result in similar protection of galvanized metals, and aluminum from copper replating and resulting galvanic corrosion.

TABLE 11

| | | | | | | Chelant | Cu ICP after | Weight |
|---|---|---|---|---|---|---|---|---|
| | | | Electrode | Copper | | Dosage | nitric ppm | Loss |
| Test | Hrs | Water | Type | ppm | Chelant | ppm Dry | (on coupon) | [mg] |
| 3 | 96 | IWT Brine | C1018 | 10 | None | 0 | 74.77 | 349.1 |
| 4 | 96 | IWT Brine | C1018 | 10 | Biochelant | 20 | 48.00 | 284.7 |

### Example 8

In an aspect, a PRO-COMP is introduced in an effective amount into the aqueous cooling medium which contains calcium hardness and an amount of trace ions sufficient to interfere with the antiprecipitation property. The trace ions can consist of one or more of Fe⁺², Fe⁺³, Al⁺³, and Mn⁺² at concentrations ranging from 0.25 mg/liter to 5 mg/liter.

The following presents the test method performed using the polymer compositions of the invention for inhibiting the precipitation of calcium phosphate in aqueous systems. The percent precipitation inhibition caused by the addition of the polymer compositions of the present invention or comparative polymers was calculated using the following formula:

(T/I)×100=Percent(%)Inhibition

Where: T equals the parts per million by weight (ppm) of phosphate ions remaining is solution at the conclusion of the test as analyzed using the ascorbic acid spectrophotometric method (APHA Standard Methods, 13th Edition, 1972, p532) and I equals the ppm of the total phosphate in the test sample. The following general procedure was used: phosphate concentration analysis: DR/900 Spectrophotometer using Hach method 8048 Phosphorus, Reactive (Orthophosphate), low range (0-2.000 milligrams/liter). Individual stock aqueous solutions containing calcium ions (1200 ppm Ca²⁺), ferrous ions (50 ppm Fe²⁺) and zinc ions (250 ppm Zn²⁺) were prepared from the corresponding chloride salts, except for the ferrous ion solution which as prepared from ferrous sulfate dihydrate. A stock solution containing phosphate ions (25 ppm PO₄³⁻), using phosphoric acid, was also prepared.

Stock solutions (adjusted to pH 8.0) containing 0.1 percent by weight of the active polymers, expressed as the acid form, were also prepared. To a 250 mL Erlenmeyer flask the following were added in this order: 40 mL of the calcium ion stock solution, then 45-49 ml of polished deionized water (makeup to 100 ml final solution), 1.0 ml or 2.0 ml of the polymer stock to yield 10 ppm or 20 ppm active polymer concentrations, respectively. 1.0 ml of the zinc stock solution and 10 ml of the phosphate stock solution was then added to 1.0 ml of the iron stock solution. One sample, referred to as “100% inhibition,” was made by mixing 10 ml of the phosphate stock solution with 90 ml of polished deionized water. Another sample, referred to as “None,” was made by mixing solutions (a, b, d, e and f) from above, with no polymer stock solution. The pH of each of the resultant mixtures was adjusted to pH 8.5. The flask were then capped and placed in water bath at 85° C. for 17 hours. At the end of this period, the flask were removed from the bath, the solutions were filtered using a 0.45 micron filter cartridge and the filtered samples was allowed to cool to room temperature. The filtered solution was then diluted and analyzed for ppm phosphate using the ascorbic acid method.

TABLE 12

| | | Dosage wet, | | Cation | |
|---|---|---|---|---|---|
| Test | Polymer | ppm | Cation | PPM | % Inhibition |
| 1 | None | — | None | 0 | 10% |
| 2 | NQ 2000/ | 10.0 | None | 0 | 18% |
| | ACUMER 2000 | | | | |
| 3 | NQ 2000/ | 20.0 | None | 0 | 38% |
| | ACUMER 2000 | | | | |
| 4 | NQ 2100/ | 10.0 | None | 0 | 88% |
| | ACUMER 2100 | | | | |
| | AA/AMPS | | | | |
| 5 | NQ 2100/ | 20.0 | None | 0 | 88% |
| | ACUMER 2100 | | | | |
| | AA/AMPS | | | | |
| 6 | NQ 3100/ | 10.0 | None | 0 | 88% |
| | ACUMER 3100 | | | | |
| | AA/AMS/TBA | | | | |
| | TERPOLYMER | | | | |
| 7 | NQ 3100/ | 20.0 | None | 0 | 89% |
| | ACUMER 3100 | | | | |
| | AA/AMS/TBA | | | | |
| | TERPOLYMER | | | | |
| 8 | NQ 3150/ | 10.0 | None | 0 | 88% |
| | ACUMER 3150 | | | | |
| 9 | NQ 3150/ | 20.0 | None | 0 | 90% |
| | ACUMER 3150 | | | | |
| 10 | NQ 5798/ | 10.0 | None | 0 | 92% |
| | CARBOSPERSE | | | | |
| | K-798 | | | | |
| 11 | NQ 5798/ | 20.0 | None | 0 | 94% |
| | CARBOSPERSE | | | | |
| | K-798 | | | | |

The deleterious effect of the trace ions on the antiprecipitation property is shown in the following table.

TABLE 13

| | | | | Cation | |
|---|---|---|---|---|---|
| Test | Polymer | Dosage wet | Cation | PPM | % Inhibition |
| 12 | None | — | Iron | 0.5 | 0% |
| 13 | NQ 2000/ | 10.0 | Iron | 0.5 | 7% |
| | ACUMER 2000 | | | | |
| 14 | NQ 2000/ | 20.0 | Iron | 0.5 | 33% |
| | ACUMER 2000 | | | | |
| 15 | NQ 2100/ | 10.0 | Iron | 0.5 | 88% |
| | ACUMER 2100 | | | | |
| | AA/AMPS | | | | |
| 16 | NQ 2100/ | 20.0 | Iron | 0.5 | 94% |
| | ACUMER 2100 | | | | |
| | AA/AMPS | | | | |
| 17 | NQ 3100/ | 10.0 | Iron | 0.5 | 87% |
| | ACUMER 3100 | | | | |
| | AA/AMS/TBA | | | | |
| | TERPOLYMER | | | | |
| 18 | NQ 3100/ | 20.0 | Iron | 0.5 | 86% |
| | ACUMER 3100 | | | | |
| | AA/AMS/TBA | | | | |
| | TERPOLYMER | | | | |
| 19 | NQ 3150/ | 10.0 | Iron | 0.5 | 89% |
| | ACUMER 3150 | | | | |
| 20 | NQ 3150/ | 20.0 | Iron | 0.5 | 90% |
| | ACUMER 3150 | | | | |
| 21 | NQ 5798/ | 10.0 | Iron | 0.5 | 92% |
| | CARBOSPERSE | | | | |
| | K-798 | | | | |
| 22 | NQ 5798/ | 20.0 | Iron | 0.5 | 91% |
| | CARBOSPERSE | | | | |
| | K-798 | | | | |
| 27 | NQ 2000/ | 20.0 | Iron | 1 | 8% |
| | ACUMER 2000 | | | | |
| 28 | NQ 2000/ | 20.0 | Iron | 3 | 5% |
| | ACUMER 2000 | | | | |
| 29 | NQ 2000/ | 20.0 | Iron | 5 | 6% |
| | ACUMER 2000 | | | | |
| 30 | NQ 5798/ | 10.0 | Iron | 1 | 88% |
| | CARBOSPERSE | | | | |
| | K-798 | | | | |
| 31 | NQ 5798/ | 10.0 | Iron | 3 | 87% |
| | CARBOSPERSE | | | | |
| | K-798 | | | | |
| 32 | NQ 5798/ | 10.0 | Iron | 5 | 88% |
| | CARBOSPERSE | | | | |
| | K-798 | | | | |
| 33 | NQ 5798/ | 10.0 | Iron | 10 | 88% |
| | CARBOSPERSE | | | | |
| | K-798 | | | | |
| 43 | NQ 2000/ | 20.0 | Mn | 3 | 3% |
| | ACUMER 2000 | | | | |
| 44 | NQ 2000/ | 20.0 | Mn | 5 | 1% |
| | ACUMER 2000 | | | | |

The effectiveness of the chelating agents in mitigating the deleterious effect of the trace ions is demonstrated in Table 14.

TABLE 14

| | | | | | | Chelant | |
|---|---|---|---|---|---|---|---|
| | | Dosage | | Cation | | Dosage | % |
| Test | Polymer | wet | Cation | PPM | Chelant | ppm dry | Inhibition |
| 23 | NQ 2000/ACUMER 2000 | 10.0 | Iron | 3 | LG60 | 15 | 11% |
| 24 | NQ 2000/ACUMER 2000 | 10.0 | Iron | 5 | LG60 | 30 | 11% |
| 25 | NQ 2000/ACUMER 2000 | 10.0 | Iron | 3 | GOGA55 | 15 | 13% |
| 26 | NQ 2000/ACUMER 2000 | 10.0 | Iron | 5 | GOGA55 | 30 | 16% |
| 34 | NQ 2000/ACUMER 2000 | 20.0 | Iron | 3 | LG60 | 15 | 20% |
| 35 | NQ 2000/ACUMER 2000 | 20.0 | Iron | 5 | LG60 | 30 | 20% |
| 36 | NQ 2000/ACUMER 2000 | 20.0 | Iron | 3 | GOGA55 | 15 | 25% |
| 37 | NQ 2000/ACUMER 2000 | 20.0 | Iron | 5 | GOGA55 | 30 | 25% |
| 38 | NQ 2000/ACUMER 2000 | 20.0 | Iron | 3 | GA50 | 15 | 23% |
| 39 | NQ 2000/ACUMER 2000 | 20.0 | Iron | 5 | GA50 | 30 | 21% |

The effectiveness of the chelating agents in mitigating the deleterious effect of the trace ions is demonstrated in Table 15. The table below shows the effect chelating agents when dosed in non-molar, threshold level dosages.

TABLE 15

| | | | | | | Chelant | |
|---|---|---|---|---|---|---|---|
| | | Dosage | | Cation | | Dosage | % |
| Test | Polymer | wet | Cation | PPM | Chelant | ppm dry | Inhibition |
| 60 | NQ 2000/ACUMER 2000 | 20.0 | Iron | 5 | GOGA55 | 2.5 | 13% |
| 61 | NQ 2000/ACUMER 2000 | 20.0 | Iron | 5 | GOGA55 | 5 | 13% |
| 62 | NQ 2000/ACUMER 2000 | 20.0 | Iron | 5 | GOGA55 | 15 | 13% |
| 63 | NQ 2000/ACUMER 2000 | 20.0 | Iron | 5 | GA50 | 2.5 | 15% |
| 64 | NQ 2000/ACUMER 2000 | 20.0 | Iron | 5 | GA50 | 5 | 15% |
| 65 | NQ 2000/ACUMER 2000 | 20.0 | Iron | 5 | GA50 | 15 | 15% |
| 66 | NQ 2000/ACUMER 2000 | 20.0 | Iron | 5 | LG60/SS60 | 2.52 | 19% |
| 67 | NQ 2000/ACUMER 2000 | 20.0 | Iron | 5 | LG60/SS60 | 5.01 | 19% |
| 68 | NQ 2000/ACUMER 2000 | 20.0 | Iron | 5 | LG60/SS60 | 15 | 20% |

TABLE 16

| Chelant | Composition |
|---|---|
| LG60 | Gluconic acid/sodium gluconate mixture |
| GOGA55 | Gluconic acid/glucaric acid/sodium gluconate/ |
| | sodium glucarate mixture |
| GA50 | Glucaric acid |

The results shown in Table 16 demonstrates given a sufficient amount of additive that gluconic acid is effective. There is also an unexpected benefit observed from the mixture of gluconic and glucaric acids. NQ3100 is a water treatment terpolymer of acrylic acid; NQ5798 is a low molecular weight organic terpolymer for scale inhibition and dispersion; NQ3150 is a high performance terpolymer of acrylic acid; NQ2000 is a copolymer of acrylic and AMPSA for use as a scale inhibitor and dispersing agent; and NQ2100 is a carboxylate sulphonate copolymer for use in boiler treatment pulp/paper processing which are commercially available form North Metal and Chemical Co. ACUMER polymer is a scale inhibitor commercially available from DOW Chemical. CARBOSPERE K-798 is an acrylate terpolymer for use as high performance deposit control components of cooling and boiler water treatment formulations commercially available from Lubrizol.

### Additional Disclosure

The following enumerated aspects of the present disclosures are provided as non-limiting examples.

### Part I

A first aspect which is a composition for a synergistic scale inhibitor and corrosion inhibitor for industrial water treatment applications, the composition comprising:a chelant comprising an aldonic, uronic, or aldaric acid, or a salt or derivative thereof, or a combination thereof; a scale inhibitor of phosphonates, organic acids, polymeric organic acids, polycarboxylics, polymers, and any combinations or derivatives thereof; a corrosion inhibitor of organic acids, phosphonates, poly and orthophosphates, zinc compounds, nitrite compounds, molybdate compounds, silicates, azoles, and any combinations or derivatives thereof; and a solvent comprising water, glycols, and alcohols.

A second aspect which is the composition of the first aspect wherein the chelant and organic acid comprises of sodium gluconate and sodium glucarate liquid oxidation product comprising predominantly gluconate and glucarate anions with minor component species of n-keto-acids and C2-C5 diacids.

A third aspect which is the composition of any of the first through second aspects wherein the chelant and organic acid comprises of gluconic acid and glucaric acid oxidation product comprising predominantly gluconic acid and glucaric acid with minor component species of n-keto-acids and C2-C5 diacids.

A fourth aspect which is the composition of any of the first through third aspects wherein the solvent comprises water, methanol, ethanol, ethylene glycol, propylene glycol, ethylene glycol monobutyl ether, or a combination thereof.

A fifth aspect which is the composition of any of the first through fourth aspects wherein the biochelant ranges from a concentration of 0.2-70% wt.

A sixth aspect which is the composition of any of the first through fifth aspects wherein the scale inhibitor ranges from a concentration of 0.2-70% wt.

A seventh aspect which is the composition of any of the first through sixth aspects wherein the corrosion inhibitor ranges from a concentration of 0.2-50% wt.

An eighth aspect which is a process for mitigating localized corrosion of metals in aqueous systems containing soluble copper, consisting of the injection of an effective dosage of a selected chelating agent.

A ninth aspect which is the process of the eighth aspect where the chelating agent is chosen based on selective chelation of Cu⁺² vs other ions in the aqueous system.

A tenth aspect which is the process of any of the eighth through ninth aspects where the chelating agent is chosen based on effectiveness in a defined pH range.

An eleventh aspect which is the process of any of the eighth through tenth aspects where the chelating agent is chosen based on biodegradability.

A twelfth aspect which is the process of any of the eighth through eleventh aspects where the chelating agent is a mixture of aldaric, uronic, acids.

A thirteenth aspect which is the process of any of the eighth through twelfth aspects wherein the chelant is a mixture of aldaric, uronic acids, and their respective counter-cation.

A fourteenth aspect which is the process of any of the eighth through thirteenth aspects wherein the chelant is comprised of glucaric acid, gluconic acid, glucuronic acid, glucose oxidation products, and gluconic acid oxidation products.

A fifteenth aspect which is the process of any of the eighth through fourteenth aspects wherein the chelant is comprised of sugar oxidation products comprising of disaccharides, oxidized disaccharides, uronic acid, and aldaric acid.

A fifteenth aspect which is the process of any of the eighth through fifteenth aspects wherein the chelant is comprised of gluconic acid, glucaric acid, glucuronic acid, n-keto-acids and other C2-C6 diacids.

A sixteenth aspect which is the process of any of the eighth through fifteenth aspects wherein the counter-cation comprises of an alkali earth metal of group 1 and group 2.

A seventeenth aspect which is the process of any of the eighth through sixteenth aspect wherein the counter-cation comprises of ammonium.

An eighteenth aspect which is the process of any of the eighth through seventeenth aspects wherein the chelant also comprises of citric acid, glutaric acid, ethylene diamine disuccinic acid, iminodisuccnic acid, methylglycine N,N-diacetic acid, glutamic acid, and their associated salts.

A nineteenth aspect which is the process of any of the eighth through eighteenth aspects where the effective dosage is determined by offline analysis of the soluble copper content of the aqueous medium in the system.

A twentieth aspect which is the process of the nineteenth aspect where effective dosage is based on the molar ratio of chelating agent to soluble copper in a range from 1/1 to 10/1.

A twenty-first aspect which is the process of any of the eighth through twentieth aspects where the dosage of chelating agent is regularly adjusted in response to changing copper levels in order to maintain an effective dosage.

A twenty-second aspect which is the process of the twenty-first aspect where the adjustment is based on assays of total soluble copper in the aqueous medium.

A twenty-third aspect which is the process of the twenty-second aspect where the assay is a manual analysis.

A twenty-fourth aspect which is the process of the twenty-second aspect where the assay is a continuous or semi-continuous automated analysis.

A twenty-fifth aspect which is the process of the twenty-second aspect where the assay is analysis of total soluble copper.

A twenty-sixth aspect which is the process of the twenty-second aspect where the assay is analysis of free (uncomplexed) Cu⁺².

A twenty-seventh aspect which is the process of the twenty-sixth aspect where the assay is conducted using an ion selective electrode.

A twenty-eighth aspect which is the process of any of the eighth through twenty-seventh aspects where the metal is steel such as stainless and galvanized steel.

A twenty-ninth aspect which is the process of any of the eighth through twenty-eighth aspects where the metal is carbon steel

A thirtieth aspect which is the process of any of the eighth through twenty-ninth aspects where the metal is aluminum or aluminum alloys.

A thirty-first aspect which is a process and composition for inhibition of scale and corrosion in aqueous systems contaminated by trace ions (Fe+2, Fe+3, Al+3, Mn+2) comprising the addition of an effective chelating agent into a system treated by phosphate-based corrosion inhibitors containing a calcium phosphate precipitation inhibitor.

A thirty-second aspect which is the process and composition of the thirty-first aspect in which the required dosage of chelant is determined by an assay of the trace ion concentration and the dosage is adjusted to a level that is effective.

A thirty-third aspect which is the process and composition of the thirty-second aspect in which the molar ratio of chelant to trace ions is greater than 0.75

A thirty-fourth aspect which is the process and composition of the thirty-second aspect in which the trace ion is ferrous or ferric.

A thirty-fifth aspect which is the process and composition of the thirty-second aspect in which the trace ion is Mn+2.

A thirty-sixth aspect which is the process and composition of the thirty-second aspect in which the trace ion is Al+3.

A thirty-seventh aspect which is the process and composition of any of the thirty-first through thirty sixth aspects in which the chelant is gluconic acid

A thirty-eighth aspect which is the process and composition of any of the thirty-first through thirty sixth aspects in which the chelant is glucaric acid.

A thirty-ninth aspect which is the process and composition of any of the thirty-first through thirty sixth aspects in which the chelant is a mixture of glucaric and gluconic acids.

A fortieth aspect which is the process and composition of any of the thirty-first through thirty-ninth aspects where the chelating agent is a mixture of aldaric, uronic, acids.

A forty-first aspect which is the process and composition of any of the thirty-first through fortieth aspects wherein the chelant is a mixture of aldaric, uronic acids, and their respective counter-cation.

A forty-second aspect which is the process and composition of any of the thirty-first through forty-first aspects wherein the chelant is comprised of glucaric acid, gluconic acid, glucuronic acid, glucose oxidation products, and gluconic acid oxidation products.

A forty-third aspect which is the process and composition of any of the thirty-first through forty-second aspects wherein the chelant is comprised of sugar oxidation products comprising of disaccharides, oxidized disaccharides, uronic acid, and aldaric acid.

A forty-fourth aspect which is the process and composition of any of the thirty-first through forty-third aspects wherein the chelant is comprised of gluconic acid, glucaric acid, glucuronic acid, n-keto-acids and other C₂-C₆ diacids.

A forty-fifth aspect which is the process and composition of any of the thirty-first through forty-fourth aspects wherein the counter-cation comprises of an alkali earth metal of group 1 and group 2.

A forty-sixth aspect which is the process and composition of any of the thirty-first through forty-fifth aspects wherein the counter-cation comprises of ammonium.

A forty-seventh aspect which is the process and composition of any of the thirty-first through forty-sixth aspects wherein the chelant also comprises of citric acid, glutaric acid, ethylene diamine disuccinic acid, iminodisuccnic acid, methylglycine N,N-diacetic acid, glutamic acid, N,N-diacetic acid and their associated salts.

### Part II

A first aspect which is a protectant composition comprising at least two of the following:(a) a biochelant; (b) a chelant; (c) an acid; (d) a scale inhibitor; (e) a corrosion inhibitor; (f) an antiprecipitation additive; (g) a soluble phosphorous compound; and (h) solvent.

A second aspect which is the composition of the first aspect wherein the biochelant is a naturally-occurring molecule or derived from a naturally-occurring molecule such as monosaccharide or polysaccharide.

A third aspect which is the composition of any of the first through second aspects wherein the biochelant comprises aldonic acid, uronic acid, aldaric acid, salts thereof, derivatives thereof, or a combination thereof

A fourth aspect which is the composition of any of the first through third aspects wherein the biochelant comprises sodium gluconate, oxidation products of sodium glucarate, one or more salts thereof, one or more derivatives thereof, or a combination thereof.

A fifth aspect which is the composition of the fourth aspect wherein the biochelant further comprises n-keto acids and C₂-C₅ diacids in amounts of less than about 50 wt. %.

A sixth aspect which is the composition of any of the first through fifth aspects wherein the chelant comprises ethylenediaminetetraacetic acid (EDTA), hydroxyethylethylenediam inetriacetic acid (HE DTA), nitrilotriacetic acid (NTA), diethylenetriaminepentaacetic acid (DTPA), ethylene diamine N,N′ disuccinic acid, citric acid, gluconic acid, glucaric acid, glutaric acid, glucoheptonic acid, glutamic acid, one or more salts thereof, or mixtures thereof.

A seventh aspect which is the composition of any of the first through sixth aspects wherein the corrosion inhibitor comprises poly/orthophosphates, phosphonates, zinc, nitrite, molybdate compounds, azoles, benzimidazoles, silicates, or a combination thereof.

An eighth aspect which the composition of any of the first through seventh aspects wherein the scale inhibitor comprises phosphonates, organic acids, polymeric organic acids, polycarboxylics, polymersATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid and sodium aspartic acid, phosphinocarboxylates, AA-AMPS (acrylic acid-2-acrylamido-2-methylpropane sulfonic acid), or a combination thereof.

A ninth aspect which is the composition of any of the first through eighth aspects wherein the acid comprises citric acid, glutaric acid, ethylene diamine disuccinic acid, iminodisuccnic acid, methylglycine N,N-diacetic acid, glutamic acid, ethylene diamine tetraacetic acid, hydroxyethyl ethylene diamine triacetic acid, diethyene triamine pentaacetic acid, one or more salts thereof, or a combination thereof.

A tenth aspect which is the composition of any of the first through ninth aspects wherein the antiprecipitation additive comprises low molecular weight organic polymers including combinations of carboxylic acid, sulfonic acid, and nonionic functional groups.

An eleventh aspect which is the composition of any of the first through tenth aspects wherein the soluble phosphorous compound comprises orthophosphate, polyphosphates such as pyrophosphate, hexametaphosphate or higher polyphosphates, organic phosphate esters, organic phosphonates, or a combination thereof. vA twelfth aspect which is the composition of any of the first through eleventh aspects wherein the solvent comprises water, ethylene glycol, diethylene glycol, triethylene glycol, tetraethylene glycol, tripropylene glycol 1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

A thirteenth aspect which is the composition of any of the first through twelfth aspects wherein the solvent comprises water, methanol, ethanol, ethylene glycol, propylene glycol, ethylene glycol monobutyl ether, or a combination thereof.

A fourteenth aspect which is a method for reducing the amount of ferric ion in a produced water, the method comprising preparing a protectant composition comprising a scale inhibitor; a biochelant; and a solvent; and introducing the composition to a produced water.

A fifteenth aspect which is the method of the fourteenth aspect wherein the comprises phosphonates, organic acids, polymeric organic acids, polycarboxylics, polymersATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid and sodium aspartic acid, phosphinocarboxylates, AA-AMPS (acrylic acid-2-acrylamido-2-methylpropane sulfonic acid), or a combination thereof.

A sixteenth aspect which is the method of any of the fourteenth through fifteenth aspects wherein the biochelant comprises aldonic acid, uronic acid, aldaric acid, one or more salts thereof, one or more derivatives thereof, or a combination thereof.

A seventeenth aspect which is a method of mitigating the formation of calcium phosphate precipitant, the method comprising preparing a composition comprising a biochelant; a soluble phosphorous compound; an antiprecipitation additive; and a solvent; and introducing the composition to a feed water disposed in a fluid conduit.

An eighteenth aspect which is the method of the seventeenth aspect, wherein the biochelant comprises aldonic acid, uronic acid, aldaric acid, one or more salts thereof, one or more derivatives thereof, or a combination thereof.

A nineteenth aspect which is the method of any of the seventeenth through eighteenth aspects wherein the soluble phosphorous compound comprises orthophosphate, polyphosphates such as pyrophosphate, hexametaphosphate or higher polyphosphates, organic phosphate esters, organic phosphonates or a combination thereof.

A twentieth aspect which is the method of any of the seventeenth through nineteenth aspects, wherein the antiprecipitation additive comprises low molecular weight organic polymers including combinations of carboxylic acid, sulfonic acid and nonionic functional groups.

A twenty-first aspect which is the method of any of the seventeenth through twentieh aspects wherein the feed water is disposed in a cooling tower or a heat exchanger.

A twenty-second aspect which is a method for mitigating galvanic corrosion comprising introducing to an aqueous system comprising: divalent copper; and a composition comprising a biochelant, an acid, and a solvent.

A twenty-third aspect which is the method of the twenty-second aspect wherein the biochelant comprises aldonic acid, uronic acid, aldaric acid, one or more salts thereof, one or more derivatives thereof, or a combination thereof.

A twenty-fourth aspect which is the method of any of the twenty-second through twenty-third aspects wherein the acid comprises citric acid, glutaric acid, ethylene diamine disuccinic acid, iminodisuccnic acid, methylglycine N,N-diacetic acid, glutamic acid, ethylene diamine tetraacetic acid, hydroxyethyl ethylene diamine triacetic acid, diethyene triamine pentaacetic acid, one or more salts thereof, or a combination thereof.

A twenty-fifth aspect which is a method for providing scale and corrosion inhibition, the method comprising introducing a composition comprising a biochelant, a scale inhibitor, a corrosion inhibitor and a solvent to a system comprising industrial water.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A protectant composition comprising at least two of the following:
(a) a biochelant;
(b) a chelant;
(c) an acid;
(d) a scale inhibitor;
(e) a corrosion inhibitor;
(f) an antiprecipitation additive;
(g) a soluble phosphorous compound; and
(h) solvent.

2. The composition of claim 1, wherein the composition comprises the biochelant, and wherein the biochelant is a naturally-occurring molecule or derived from a naturally-occurring molecule such as monosaccharide or polysaccharide.

3. The composition of claim 1, wherein the composition comprises the biochelant, and wherein the biochelant comprises aldonic acid, uronic acid, aldaric acid, salts thereof, derivatives thereof, or a combination thereof

4. The composition of claim 1, wherein the composition comprises the biochelant, and wherein the biochelant comprises sodium gluconate, oxidation products of sodium glucarate, one or more salts thereof, one or more derivatives thereof, or a combination thereof.

5. The composition of claim 4, wherein the biochelant further comprises n-keto acids and C₂-05 diacids in amounts of less than about 50 wt. %. Appl. No. Not Yet Assigned

6. The composition of claim 1, wherein the composition comprises the chelant, and wherein the chelant comprises ethylenediaminetetraacetic acid (EDTA), hydroxyethylethylenediam inetriacetic acid (HEDTA), nitrilotriacetic acid (NTA), diethylenetriaminepentaacetic acid (DTPA), ethylene diamine N,N′ disuccinic acid, citric acid, gluconic acid, glucaric acid, glutaric acid, glucoheptonic acid, glutamic acid, one or more salts thereof,or mixtures thereof.

7. The composition of claim 1, wherein the composition comprises the corrosion inhibitor, and wherein the corrosion inhibitor comprises poly/orthophosphates, phosphonates, zinc, nitrite, molybdate compounds, azoles, benzimidazoles, silicates, or a combination thereof.

8. The composition of claim 1, wherein the composition comprises the scale inhibitor, and wherein the scale inhibitor comprises phosphonates, organic acids, polymeric organic acids, polycarboxylics, polymersATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid and sodium aspartic acid, phosphinocarboxylates, AA-AMPS (acrylic acid-2-acrylamido-2-methylpropane sulfonic acid), or a combination thereof.

9. The composition of claim 1, wherein the composition comprises the acid, and wherein the acid comprises citric acid, glutaric acid, ethylene diamine disuccinic acid, iminodisuccnic acid, methylglycine N,N-diacetic acid, glutamic acid, ethylene diamine tetraacetic acid, hydroxyethyl ethylene diamine triacetic acid, diethyene triamine pentaacetic acid, one or more salts thereof, or a combination thereof.

10. The composition of claim 1, wherein the composition comprises the antiprecipitation additive, and wherein the antiprecipitation additive comprises low molecular weight organic polymers including combinations of carboxylic acid, sulfonic acid, and nonionic functional groups.

11. The composition of claim 1, wherein the composition comprises the soluble phosphorous compound, wherein the soluble phosphorous compound comprises orthophosphate, polyphosphates such as pyrophosphate, hexametaphosphate or higher polyphosphates, organic phosphate esters, organic phosphonates, or a combination thereof.

12. The composition of claim 1, wherein the composition comprises the solvent, wherein the solvent comprises water, ethylene glycol, diethylene glycol, triethylene glycol, tetraethylene glycol, tripropylene glycol 1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

13. The composition of claim 1, wherein the composition comprises the solvent, wherein the solvent comprises water, methanol, ethanol, ethylene glycol, propylene glycol, ethylene glycol monobutyl ether, or a combination thereof.

14. A method for reducing the amount of ferric ion in a produced water, the method comprising:
preparing a protectant composition comprising:
a scale inhibitor;
a biochelant; and
a solvent; and
introducing the composition to a produced water.

15. The method of claim 14 wherein the comprises phosphonates, organic acids, polymeric organic acids, polycarboxylics, polymersATMP (am inotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid and sodium aspartic acid, phosphinocarboxylates, AA-AMPS (acrylic acid-2-acrylamido-2-methylpropane sulfonic acid), or a combination thereof.

16. The method of claim 14, wherein the biochelant comprises aldonic acid, uronic acid, aldaric acid, one or more salts thereof, one or more derivatives thereof, or a combination thereof.

17. A method of mitigating the formation of calcium phosphate precipitant, the method comprising:
preparing a composition comprising:
a biochelant;
a soluble phosphorous compound;
an antiprecipitation additive; and
a solvent; and
introducing the composition to a feed water disposed in a fluid conduit.

18. The method of claim 17, wherein the biochelant comprises aldonic acid, uronic acid, aldaric acid, one or more salts thereof, one or more derivatives thereof, or a combination thereof.

19. The method of claim 17, wherein the soluble phosphorous compound comprises orthophosphate, polyphosphates such as pyrophosphate, hexametaphosphate or higher polyphosphates, organic phosphate esters, organic phosphonates or a combination thereof.

20. The method of claim 17, wherein the antiprecipitation additive comprises low molecular weight organic polymers including combinations of carboxylic acid, sulfonic acid and nonionic functional groups.

21. The method of claim 17, wherein the feed water is disposed in a cooling tower or a heat exchanger.

22. A method for mitigating galvanic corrosion comprising
introducing to an aqueous system comprising:
divalent copper; and
a composition comprising a biochelant, an acid, and a solvent.

23. The method of claim 22, wherein the biochelant comprises aldonic acid, uronic acid, aldaric acid, one or more salts thereof, one or more derivatives thereof, or a combination thereof.

24. The method of claim 23, wherein the acid comprises citric acid, glutaric acid, ethylene diamine disuccinic acid, iminodisuccnic acid, methylglycine N,N-diacetic acid, glutamic acid, ethylene diamine tetraacetic acid, hydroxyethyl ethylene diamine triacetic acid, diethyene triamine pentaacetic acid, one or more salts thereof, or a combination thereof.

25. A method for providing scale and corrosion inhibition, the method comprising:
introducing a composition comprising a biochelant, a scale inhibitor, a corrosion inhibitor and a solvent to a system comprising industrial water.
